(19) United States
(12) Patent Application Publication
(10) Pub. No.: US 2006/0166044 A1
(43) Pub. Date: Jul. 27, 2006

(54) Fuel cell protection

(76) Inventor: Pierre Charlat, Lans En Vercors (FR)

Correspondence Address: Air Liquide;Intellectual Property Department, Suite 1800, 2700 Post Oak Boulevard, Houston, TX, 77056, US

(21) Appl. No.: 10/559,976

(22) PCT Filed: Jun. 17, 2004
(86) PCT No.: PCT/FR04/50276

§ 371 Date: Mar. 22, 2006

(30) Foreign Application Priority Data
Jun. 20, 2003 (FR) 0307471

(51) Int. Cl. H01M 14/00

(52) U.S. Cl. 429/7

(57) ABSTRACT

The invention relates to a method of protecting a fuel cell (12) comprising elementary cells, whereby said cell is supplying electric power in response to a power demand. Moreover, a booster circuit (30) is adapted to supply complementary electric power in order to assist the fuel cell. The inventive method comprises the following steps consisting in: determining a parameter that is representative of the minimum voltage from among the voltages at the terminals of each elementary cell; and controlling the complementary electric power supplied by the booster circuit, such that the minimum voltage remains above a determined threshold. The invention also relates to a fuel cell booster device.

The present invention relates to a method of protecting a fuel cell and to a fuel cell booster circuit for implementing the method of protection.

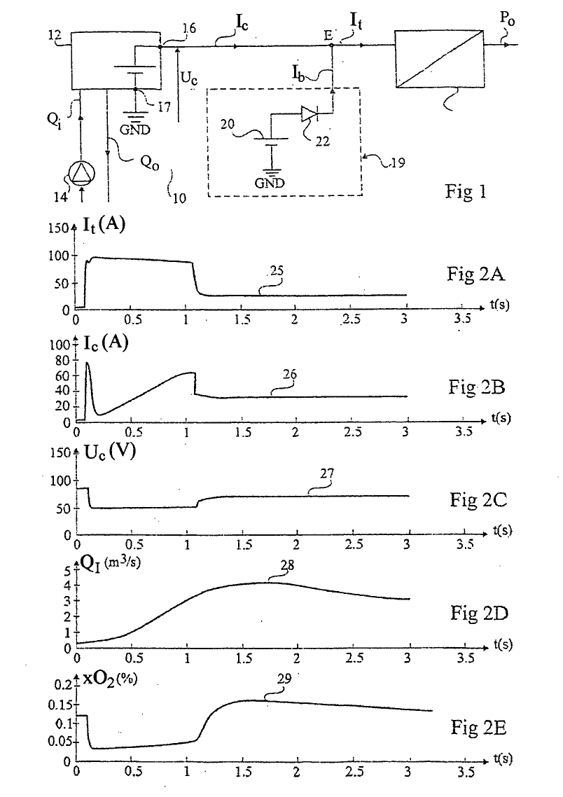

FIG. 1 shows an example of a conventional architecture of a power generator 10 comprising a fuel cell 12. The fuel cell 12 receives a stream of feed air driven by a compressor 14 at a feed rate Qᵢ and discharges a stream of exhaust air at a discharge rate Qₒ. The fuel cell 12 consists of a set of individual cell elements (not shown) arranged in series and can be represented, schematically, by a voltage generator for generating a voltage between two terminals 16, 17. A chemical electrolysis reaction consuming oxygen delivered by the stream of feed air takes place in each individual cell element. The voltage across the terminals 16, 17 of the fuel cell 12, or the cell voltage, is noted by U_{c} and the current delivered by the fuel cell 12, or the cell current, is denoted by I_{c}. The terminal 17 is connected to a reference potential GND, for example ground, and the terminal 16 is connected to an input node E of a power converter 18. The converter 18 delivers power Pₒ demanded by a user, called hereafter the user power.

The power generator 10 includes a booster circuit 19 comprising a battery 20 and a diode 22 that are connected in series. One terminal of the battery 20 is connected to the anode of the diode 22 and the other terminal is connected to ground GND. The cathode of the diode 22 is connected to the node E. The booster circuit 19 delivers a current I_{b} or booster current in order to assist the fuel cell 12. The battery 20 is recharged by a battery charger (not shown).

The total current Iₜ received by the power converter 18 corresponds to the sum of the cell current I_{c} and of the booster current I_{b}. In normal operation, all of the current Iₜ is delivered by the cell, and the booster current I_{b} is zero. During rapid large transients in the user power Pₒ, the fuel cell 12 does not necessarily have the capacity to immediately deliver all of the current Iₜ demanded. The cell voltage U_{c} consequently tends to drop suddenly. The diode D is then turned on and the booster circuit 19 temporarily delivers a booster current I_{b} in order to meet the user power demand until the fuel cell is capable of delivering all of the demanded current Iₜ.

FIGS. 2A to 2E show in greater detail for example the time variation of characteristic signals of the power generator 10 of FIG. 1 during a transient in the user power PO. Curves 25 to 29 show the total current Iₜ, the cell current I_{c}, the cell voltage U_{c}, the feed air rate Qᵢ and the oxygen content xO₂ of the stream of exhaust air, respectively. The power Pₒ is equal, in succession, to idle power (for example 200 watts) for 0.1 seconds, to twice the nominal power of the fuel cell 12 (for example 4 kilowatts) for one second and, finally, to the nominal power of the fuel cell 12.

When the user power Pₒ is equal to the idle power, the oxygen content xO₂ is substantially equal to 12%. This corresponds to a steady-state situation for which the stoichiometric oxygen consumption factor of the overall chemical reaction that takes place within the fuel cell 12 is around 2. The air feed rate Qᵢ then stabilizes, so as to ensure such a stoichiometric factor. The total current Iₜ is entirely delivered by the fuel cell 12 and the cell voltage U_{c} is high.

When the user power Pₒ increases to twice the nominal power, the total current Iₜ suddenly increases and the cell voltage U_{c} suddenly drops, before stabilizing to about 50 volts.

The compressor 14 receives a specified setpoint for the air feed rate Qᵢ on the basis of the total current Iₜ. However, the inertia of the compressor 14 results in a delay between the moment when the compressor receives a specified setpoint and the moment when the compressor 14 delivers the feed air at the rate Qᵢ corresponding to the specified setpoint. A few seconds are therefore needed for the air feed rate Qᵢ to increase.

Just after the user power Pₒ has increased to twice the nominal power, the fuel cell 12 again has enough air to deliver all of the total current Iₜ for a short period (for about 0.1 s). However, since the speed of the compressor 14 has not yet increased, the fuel cell 12 receives air at a rate Qᵢ that is substantially identical to the rate of air received when the user power Pₒ was equal to the idle power. The fuel cell 12 therefore consumes all the oxygen available to it in its internal volume. This may be confirmed by the curve shown in FIG. 2E by the drop in oxygen content xO₂ in the stream of exhaust air. When the xO₂ content reaches about 4%, some of the cell elements of the fuel cell 12 that are less well supplied, especially because of very small geometrical differences at manufacture, see their voltage drop just below zero. The polarity of such cells is therefore reversed. This causes an additional drop in the cell voltage U_{c}, so that the diode 22 is turned on and allows the battery 20 to deliver part of the total current Iₜ. The current delivered by the cell I_{c} then drops and stabilizes at a value twice the value corresponding to the idle power. This corresponds to a stoichiometric oxygen consumption factor of the overall chemical reaction within the fuel cell 12 equal to 1. Practically all the oxygen introduced into the fuel cell 12 is therefore consumed.

Next, as the speed of the compressor 14 increases so the air feed rate Qᵢ and the cell current I_{c} increase. Throughout this phase, the stoichiometric oxygen consumption factor remains equal to 1 and the oxygen content xO₂ remains less than 4%. An increasingly high current therefore flows through the cell elements of the fuel cell 12 that have their polarity reversed. There is therefore a risk of such cell elements being damaged, thus reducing their lifetime.

The aim of the present invention is to provide a method for protecting a fuel cell and to provide a fuel cell booster circuit for implementing the method of protection, preventing the phenomenon of polarity reversal of cell elements of the fuel cell during user power transients.

The object of the present invention is also to provide a fuel cell booster circuit for implementing the method of protection which is of simple design and requires little modification of the architecture of the power generator.

To achieve these objects, the present invention provides a method of protecting a fuel cell, consisting of individual cell elements, delivering electric power in response to a power demand, a booster circuit being suitable for delivering additional electric power in order to assist the fuel cell, consisting in the following: a parameter representative of the minimum voltage is determined from among the voltages across the terminals of each individual cell element; and the additional electric power delivered by the booster circuit is controlled so that said minimum voltage remains above a specified threshold.

According to one way of implementing the invention, the booster circuit maintains the voltage across the terminals of the fuel cell on the basis of a setpoint determined from said parameter.

According to one way of implementing the invention, the individual cell elements of the fuel cell are supplied with oxygen by a stream of feed air, the fuel cell discharging a stream of exhaust air, said parameter being the image of the oxygen content of the stream of exhaust air, and the booster circuit delivering additional electric power so that the oxygen content is above a specified threshold.

According to one way of implementing the invention, said parameter is the image of the derivative of the voltage across the terminals of the fuel cell, the booster circuit delivering additional electric power in order for the derivative of the voltage across the terminals of the fuel cell to be above a specified threshold.

According to one way of implementing the invention, the control of the additional electric power delivered by the booster circuit consists in determining an image current that is the image of the current delivered by the fuel cell; in filtering the image current by a low-pass filter; in delivering a comparison signal equal to the sum of a constant and of the filtered image current multiplied by a correction coefficient; and in controlling the additional electric power delivered by the booster circuit so that the image current of the current delivered by the fuel cell converges on the comparison signal.

The present invention also provides a booster device for a fuel cell, consisting of a set of individual cell elements and suitable for delivering electric power in response to a power demand, said device being suitable for delivering additional electric power in order to assist the fuel cell, which device comprises a circuit for determining a parameter representative of the minimum voltage from among the voltages across the terminals of each individual cell element; and a circuit for controlling the additional electric power delivered so that said minimum voltage remains strictly positive.

According to one embodiment of the invention, the device further includes a voltage source; a circuit for delivering a setpoint; and a chopper circuit connected to the voltage source, which receives said setpoint and fixes the voltage across the terminals of the fuel cell on the basis of said setpoint.

According to one embodiment of the invention, the circuit for delivering the setpoint comprises: a circuit for determining an image current that is the image of the current delivered by the fuel cell; a circuit for determining a comparison signal equal to the sum of a constant and of the image current multiplied by a correction coefficient; a comparison circuit that delivers an error signal corresponding to the difference between the image current and the comparison signal; and a regulator that delivers the setpoint in order to minimize the error signal.

According to one embodiment of the invention, the regulator is of the integral or proportional-integral type.

These objects, features and advantages, and also others of the present invention will be explained in detail in the following description of particular embodiments, given by way of nonlimiting example and in conjunction with the appended figures in which:

FIG. 1, described above, shows a conventional architecture of a fuel cell power generator;

FIGS. 2A to 2E, described above, show the variation in characteristic parameters of the power generator of FIG. 1 during a power transient;

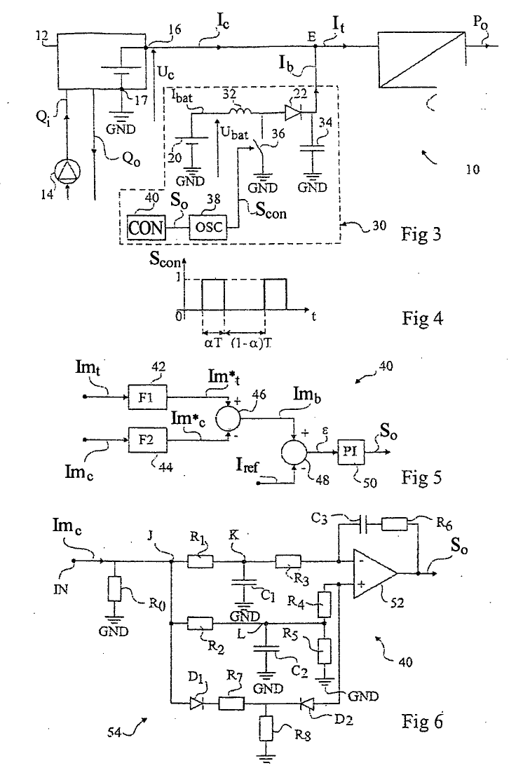

FIG. 3 shows, schematically, a fuel cell power generator comprising an exemplary embodiment of a booster circuit according to the invention;

FIG. 4 shows an example of a control signal used by the booster circuit of FIG. 3;

FIG. 5 shows schematically a first embodiment of a control circuit for the booster circuit of FIG. 3;

FIG. 6 shows a second embodiment of the control circuit;

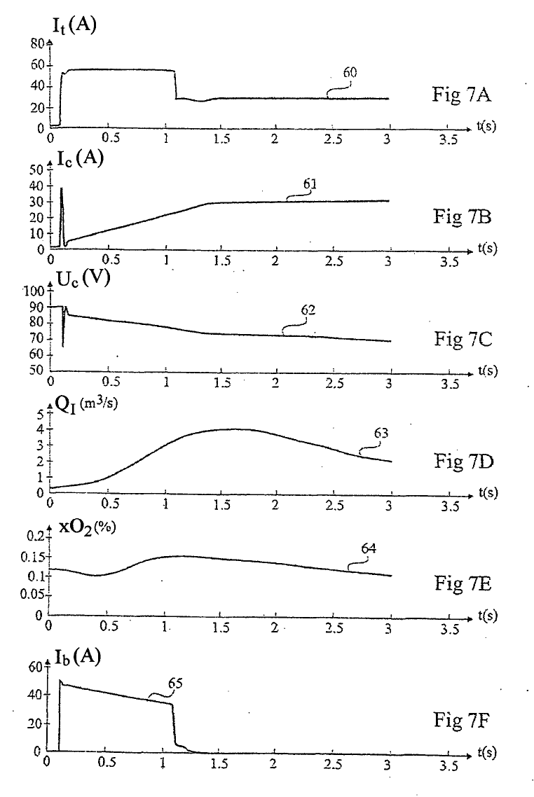

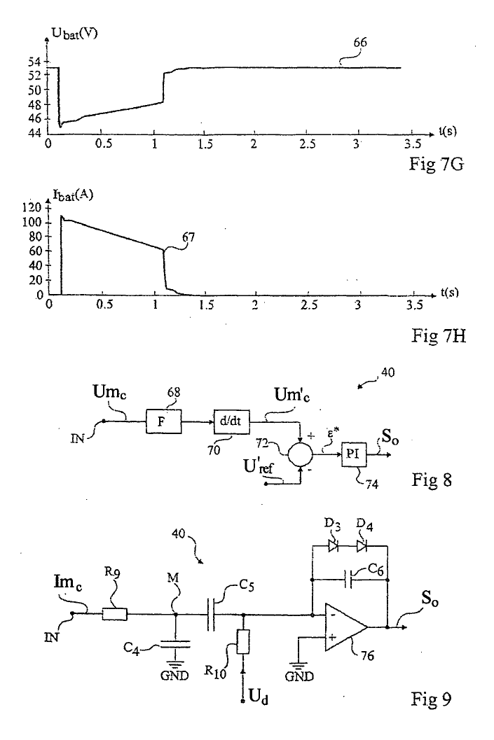

FIGS. 7A to 7H show the variation in characteristic parameters of the power generator of FIG. 3 during a power transient;

FIG. 8 shows schematically a third embodiment of the control circuit; and

FIG. 9 shows a more detailed exemplary embodiment of the control circuit of FIG. 8.

In the various figures, identical elements are denoted by identical references.

The method of protection according to the present invention consists in providing a booster circuit suitable for assisting the fuel cell 12 before certain individual cell elements of the fuel cell 12 undergo polarity reversal.

FIG. 3 shows a power generator 10 similar to the generator shown in FIG. 1, equipped with a booster circuit 30 according to the invention. The booster circuit 30 comprises an inductor 32 connected in series with the battery 20, between the battery 20 and the diode 22, a capacitor 34, one terminal of which is connected to the cathode of the diode 22 and the other terminal of which is connected to ground GND, and a controlled switch 36, one terminal of which is connected to the anode of the diode 22 and the other terminal of which is connected to ground GND. The switch 36, consisting for example of an MOS transistor, is controlled by a control signal S_{con} delivered by an oscillator circuit 38 (OSC) on the basis of a setpoint Sₒ delivered by a control circuit 40 (CON). The circuit consisting of the controlled switch 36, the inductor 32 and the capacitor 34 corresponds to a chopper circuit. The booster circuit 30 therefore imposes a cell voltage U_{c} that depends on the setpoint Sₒ. The voltage across the terminals of the battery 20 and the current delivered by the battery 20 are denoted by U_{bat} and I_{bat}, respectively.

FIG. 4 shows an example of the time variation of the control signal S_{con}. This is a rectangular wave signal, of periodic duty cycle a and period T, varying for example between the zero value (“0”) and a high value (“1”). The setpoint Sₒ delivered by the control circuit 40 is the image of the duty cycle α. The oscillating circuit 38 is designed in a conventional manner and will not be described further below. When the duty cycle α is equal to zero, the booster circuit 30 shown in FIG. 3 is approximately equivalent to the booster circuit 19 shown in FIG. 1, given the small amount of energy stored in the inductor 32 and the capacitor 34 relative to the energy present in the battery 20 and that present in the fuel cell 12.

FIG. 5 shows schematically a first embodiment of the control circuit 40. The control circuit 40 receives a current Imₜ that is the image of the total current Iₜ, and a current Imₚ that is the image of the cell current Iₚ. A first low-pass filter 42 (F1) receives the current Imₜ and delivers a filtered current Imₜ*. A second low-pass filter 44 (F2) receives the current Imp and delivers a filtered current Imc*. The filters 42, 44 eliminate the excessively sudden variations in the currents Imₜ and Imₚ. A subtractor 46 delivers a current Im_{b} equal to the difference between the currents Imₜ* and Imc*. The current Im_{b} therefore corresponds to the image of the current delivered by the booster circuit 30. A second subtractor 48 determines an error signal ε equal to the difference between the current Im_{b} and a reference current I_{ref}. A regulator 50 (PI) of the proportional-integral type receives the error signal ε and delivers the setpoint Sₒ.

By choosing a time constant of the filter 42 such that the delay induced by the filter 42 corresponds to the delay of the compressor 14, the current Imₜ* is representative of the drive speed of the compressor 14. The current Imc* is representative of the influence of the cell current on the amount of oxygen in the fuel cell 12. The current Im_{b} is then representative of the amount of oxygen present in the fuel cell 12, that is to say representative of the oxygen content xO₂ in the stream of exhaust air. The method of correction according to the first way of implementing the invention consists in ensuring that the oxygen content xO₂ is always above a reference amount, for example 10%. This ensures that in no case does the voltage across the terminals of one of the individual cell elements of the fuel cell 12 drop below zero volts.

The regulation of the control circuit 40 is also designed in such a way that the cell current I_{c} does not increase too suddenly and therefore limits the rising slope of the cell current I_{c}. In addition, the regulation must be sufficiently insensitive to prevent a booster current I_{b} being delivered when the variation in the total current Iₜ is sufficiently rapid and small. Such variations correspond for example to low-frequency oscillations, which may arise when the voltage delivered to the customer is a single-phase AC voltage, or to interference, for example electromagnetic interference, in the current sensors. Furthermore, intrinsic protection of the operation of the booster circuit 40 must prevent a booster current I_{b} being delivered if the cell voltage U_{c} exceeds a specified threshold. Finally, a negative booster current I_{b} must not be delivered to the input of the fuel cell 12.

FIG. 6 shows a second exemplary embodiment of the control circuit 40 according to the invention. The setpoint Sₒ is determined in such a way that the image current Im_{c}, the image of the cell current I_{c}, never exceeds a state value βImc*+I₀. The filtered current Imc* is obtained from Im_{c} by a first-order or a second-order low-pass filter with a time constant of the order of a few tenths of a second. The current I₀ corresponds to a constant value and is the image of the current delivered by the fuel cell 12 when the compressor 14 is idling. The coefficient β is a constant greater than 1, for example around 1.2. Regulation is obtained by a regulator of the proportional-integral type.

The control circuit 40 receives the current Im_{c} at an input terminal IN. A resistor R₀ connects the mid-point between the input terminal IN and a node J to ground GND. The node J constitutes the input point of a first low-pass filter consisting of a resistor R₁ placed between the node E and a node K and a capacitor C₁ placed between the node K and ground GND. The node J constitutes the input point of a second low-pass filter consisting of a resistor R₂ placed between the node J and a node L, and of a capacitor C₂ placed between the node G and ground GND. The node K is connected to the inverting input (−) of an operational amplifier 52 via a resistor R₃. The node L is connected to the noninverting input (+) of the operational amplifier 52 via a resistor R₄. A resistor R₅ is placed between the inverting input of the operational amplifier 52 and ground GND. The operational amplifier 52 delivers the setpoint Sₒ. The inverting input of the operational amplifier 52 is connected to the output of the operational amplifier 52 via a capacitor C₃ connected in series with a resistor R₆. The circuit formed by the resistors R₄, R₅, R₆ and the capacitor C₃ constitutes a regulator of the proportional-integral type. The control circuit 40 includes a protection circuit 54 comprising a diode D₁, a resistor R₇ and a diode D₂, these components being connected in series between the node J and the noninverting input. The anode of the diode D₁ is connected to the node J and the anode of the diode D₂ is connected to the noninverting input. A resistor R₈ connects the cathode of the diode D₂ to ground GND.

The first low-pass filter has a pass band of a few tens of hertz in order to give the control circuit 40 greater robustness. Furthermore, such a filter is not a problem as long as the reaction time of the regulation of the voltage U_{c} is shorter than the time that causes the reserve of oxygen in the fuel cell 12 to decrease (which is generally equal to a few tens of milliseconds).

To give an example, for a cell current I_{c} varying between 0 and 100 amps, the current Im_{c} may vary substantially between 4 and 20 milliamps. The non zero value of the current Im_{c} associated with the zero value of the cell current I_{c} allows the constant I₀ of the regulation to be obtained. The coefficient β is set by the resistor R₄. As an example, the operational amplifier delivers a setpoint Sₒ that varies between 0 and 5 volts, for the delivery of a cell voltage U_{c} that varies between 45 and 90 volts. For example, to obtain such a regulation, the resistors R₀, R₁, R₂, R₃, R₄, R₅, R₆, R₇ and R₈ are equal to 250 ohms, 4.7 kilohms, 4.7 kilohms, 22 kilohms, 100 kilohms, 47 kilohms, 100 kilohms, 1 kilohm and 10 kilohms, respectively. The capacitors C₁, C₂ and C₃ have capacitances of 100 microfarads, 2.2 microfarads and 22 nanofarads, respectively. The operational amplifier 52 is of the LM6142 type. The diodes D₁, D₂ are for example of the 1N4148 type.

When the cell voltage that would be obtained with a given control signal S_{con} is below the actual voltage U_{c} of the cell, the booster circuit 30 cannot actually deliver the voltage corresponding to the control signal S_{con}. Such a case corresponds to the steady state for which the value of the duty cycle has to be strictly equal to zero.

When the booster circuit 30 assists the fuel cell 12, the cell voltage U_{c} obtained by the regulation must preferably not increase too slowly. The minimum level of the cell voltage U_{c} obtained by the regulation is therefore maintained at a value slightly below the average cell voltage. The cell voltage U_{c} obtained by the regulation is therefore designed to saturate at a minimum value well above zero, for example 45 volts.

The protection circuit 54 speeds up the reduction in the setpoint Sₒ when the current Im_{c} suddenly decreases, in order to prevent current being reinjected into the fuel cell 12.

FIGS. 7A to 7H show curves 60 to 67 representative of the time variation of the total current Iₜ, of the cell current I_{c}, of the cell voltage U_{c}, of the air feed rate Qᵢ, of the oxygen content xO₂ in the stream of exhaust air, of the current I_{b} of the booster circuit, of the battery voltage U_{bat} and of the battery current I_{bat}, respectively, for the same power transient as in FIGS. 2A to 2E with the control circuit 30 shown in FIG. 6.

At the moment when the user power goes from an idle level to twice the nominal power, the fuel cell 12 starts to deliver, for a very short time, almost all of the total current Iₜ demanded, consuming the oxygen that it contains. The booster circuit 30 then delivers almost immediately almost all of the total current Iₜ. The cell current I_{c} therefore suddenly drops and then slowly increases as the speed of the compressor 14 increases. The method of protection according to the invention is therefore well able to limit the drop in the oxygen content xO₂, and therefore in the voltages across the terminals of the individual cell elements of the fuel cell 12. Thus, any deterioration of the cell elements of the fuel cell 12 is avoided.

FIG. 8 illustrates schematically a third embodiment of the control circuit 40 in which the regulation ensures that the derivative of the cell voltage U_{c} is always above a specified threshold U′_{ref}. This thus prevents a sudden drop in the cell voltage U_{c}, which is a good indicator signaling the risk that the voltages across the terminals of certain individual cell elements of the fuel cell 12 have fallen below zero. The risk of cell elements of the fuel cell 12 deteriorating is thus reduced.

The input terminal IN of the control circuit 40 receives an image voltage Um_{c} that is the image of the cell voltage U_{c}. The voltage Um_{c} is delivered by a low-pass filter 68 (F), for example a first-order filter. A derivator 70 (d/dt) receives the output from the low-pass filter 68 and delivers a signal Um′_{c} that is the image of a derivative of the cell voltage U_{c}. A subtractor 72 delivers an error signal ε* equal to the difference between the signal Um′_{c} and the reference threshold U′_{ref} to a regulator 74, for example of the proportional-integral type, which delivers the setpoint Sₒ.

FIG. 9 shows a more detailed exemplary embodiment of the control circuit 40 of FIG. 8. The input terminal IN that receives the voltage U_{c} corresponds to the input of a low-pass filter consisting of a resistor R₉ connected between the input terminal IN and a node M, and a capacitor C₄ connected between the node M and ground GND. A derivator is formed by a capacitor C₅ connected between the node M and the inverting input (−) of an operational amplifier 76. A resistor R₁₀ is connected between the inverting input and a defined potential U_{d}. The noninverting input (+) of the operational amplifier 76 is connected to ground GND. In the present embodiment, the regulator is of the pure integral type and comprises a capacitor C₆ connected between the inverting input and the output of the operational amplifier 76. The operational amplifier 76 delivers the setpoint Sₒ. Two diodes D₃, D₄ in series are connected in parallel with the capacitor C₆. The anode of the diode D₃ is connected to the inverting input of the operational amplifier 76 and the cathode of the diode D₄ is connected to the output of the operational amplifier 76.

The resistor R₇ regulates the threshold U′_{ref}. The diodes D₃, D₄ impose a value slightly below zero (here, about −1.2 volts) for saturating the integral of the regulator. This integral will rapidly exceed the zero value at the moment of a transient for greater rapidity (otherwise this integral saturates the negative supply voltage of the operational amplifier 76, well below 0 volts.

The present invention provides a method of protecting a fuel cell of a power generator that allows the power delivered by the fuel cell to be regulated so as to prevent the individual cell elements making up the fuel cell from deteriorating.

Of course, the present invention is capable of various alternative embodiments and modifications that will become apparent to those skilled in the art. In particular, the battery of the booster circuit may be replaced with an accumulator, a bank of capacitors, a super capacitor, etc.

1-9. (canceled)

10. A method of protecting a fuel cell, consisting of individual cell elements, delivering electric power in response to a power demand, a booster circuit being suitable for delivering additional electric power in order to assist the fuel cell, wherein said method comprises the following steps:
a) a parameter representative of the minimum voltage is determined from among the voltages across the terminals of each individual cell element; and
b) the additional electric power delivered by the booster circuit is controlled so that said minimum voltage remains above a specified threshold.

11. The method of claim 10, in which the booster circuit maintains the voltage across the terminals of the fuel cell on the basis of a setpoint (Sₒ) determined from said parameter.

12. The method of claim 10, in which the individual cell elements of the fuel cell are supplied with oxygen by a stream of feed air, the fuel cell discharging a stream of exhaust air, said parameter being the image of the oxygen content (xO₂) of the stream of exhaust air, and the booster circuit delivering additional electric power so that the oxygen content is above a specified threshold.

13. The method of claim 10, in which said parameter is the image of the derivative of the voltage across the terminals of the fuel cell, the booster circuit delivering additional electric power in order for the derivative of the voltage across the terminals of the fuel cell to be above a specified threshold.

14. The method of claim 10, in which the operation of controlling the additional electric power delivered by the booster circuit consists, in the following steps #5:
a) in determining an image current (Imₚ) that is the image of the current (Iₚ) delivered by the fuel cell;
b) in filtering the image current by a low-pass filter;
c) in delivering a comparison signal equal to the sum of a constant (I₀) and of the filtered image current multiplied by a correction coefficient (β); and
d) in controlling the additional electric power delivered by the booster circuit so that the image current of the current delivered by the fuel cell converges on the comparison signal.

15. A booster device for a fuel cell, consisting of a set of individual cell elements and suitable for delivering electric power in response to a power demand, said device being suitable for delivering additional electric power in order to assist the fuel cell, wherein it comprises:
a) a circuit for determining a parameter representative of the minimum voltage from among the voltages across the terminals of each individual cell element; and
b) a circuit for controlling the additional electric power delivered so that said minimum voltage remains strictly positive.

16. The device of claim 15, which further includes:
a) a voltage source;
b) a circuit for delivering a setpoint (Sₒ); and
c) a chopper circuit connected to the voltage source, which receives said setpoint and fixes the voltage across the terminals of the fuel cell on the basis of said setpoint.

17. The device of claim 16, in which the circuit for delivering the setpoint (Sₒ) comprises:
a) a circuit for determining an image current (Imₚ) that is the image of the current (Iₚ) delivered by the fuel cell;
b) a circuit for determining a comparison signal equal to the sum of a constant (I₀) and of the image current multiplied by a correction coefficient (β);
c) a comparison circuit that delivers an error signal (ε) corresponding to the difference between the image current and the comparison signal; and
d) a regulator that delivers the setpoint in order to minimize the error signal.

18. The device of claim 17, in which the regulator is of the integral or proportional-integral type.
